(19) United States
(12) Patent Application Publication
(10) Pub. No.: US 2006/0083985 A1
(43) Pub. Date: Apr. 20, 2006

(54) Electrochemical cell having improved gasket

(75) Inventor: Thomas L. Dunham, Dodgeville, WI (US)

Correspondence Address: SENNIGER POWERS, ONE METROPOLITAN SQUARE, 16TH FLOOR, ST LOUIS, MO, 63102, US

(73) Assignee: Rayovac Corporation, Madison, WI (US)

(21) Appl. No.: 10/965,139

(22) Filed: Oct. 14, 2004

(51) Int. Cl. H01M 2/08; H01M 2/06

(52) U.S. Cl. 429/185; 429/181; 29/623.2

(57) ABSTRACT

An electrochemical cell such as an alkaline battery has improved shelf-life and manufacturability. The cell has a gasket for sealing an open end of a metal container of the battery that forms a seal with a current collector shank of the battery without introducing cracks or other defects in the gasket that can lead to failure of the seal over time. Moreover, the gasket is configured to fix the current collector relative to the gasket upon assembly with the gasket so that the components of the subassembly remain fixed in position relative to each other during manufacture. A method of assembling an electrochemical cell is also disclosed.

### BACKGROUND

This invention relates generally to electrochemical cells and more particularly to an electrochemical cell having an improved gasket.

The present invention has particular application to electrochemical cells in the form of alkaline batteries (i.e., alkaline manganese dioxide electrochemical cells). However, the invention is not limited to alkaline manganese dioxide electrochemical cells, but can be practiced with a wide variety of cell structures incorporating a wide variety of combinations of electrochemical reactants well known in the art. For example, the invention can be applied to alkaline manganese dioxide cells, and lithium cells, as well as primary and rechargeable cells.

An alkaline manganese dioxide electrochemical cell typically includes a centrally disposed zinc anode surrounded by a tubular manganese dioxide cathode. The anode and cathode are disposed in close, but physically spaced relation within a metal container having an open top end. Separating structure, such as a paper tube, is used to physically separate the anode and cathode. Electrical connection to the anode is achieved by inserting an elongate metal rod, commonly referred to as a negative current collector or nail, into the zinc anode. The current collector may be made of brass or other suitable metal. The current collector extends through a resilient and electrically nonconductive gasket that closes the open end of the container, sealing the zinc anode material and manganese dioxide cathode material within the container. The top end of the current collector protrudes above the gasket for physical and electrical connection to an electrically conductive negative terminal plate. A primary length of the elongate shank of the current collector is inserted into the zinc anode material. A small portion of the shank of the current collector resides within the gasket, in sealing engagement therewith.

An electrolyte is placed in the container and generally permeates the cathode, the anode and the separating structure to provide a medium for the transfer of electrons within the cell. The electrolyte will flow within the container, and loss of electrolyte from the container will cause the cell to cease functioning within specified parameters. Alkaline electrolytes such as aqueous potassium hydroxide and sodium hydroxide are difficult to seal within the container. These alkaline electrolytes have an affinity for wetting metal surfaces and are known to creep through the sealed gasket/metal interface of an electrochemical cell. Leakage in this manner depletes the electrolyte from the cell and also causes a corrosive deposit on the surface of the cell that detracts from the cell's appearance and marketability. These corrosive salts may also damage the device in which the cell is housed. Electrochemical cells where this problem is encountered include silver oxide-zinc cells, nickel-cadmium cells, air depolarized cells, and alkaline manganese dioxide cells.

To alleviate the problem of electrolyte leakage, the gasket bears against and tightly seals around the current collector. Generally, the gasket must be made of a material inert to the electrolyte contained in the electrochemical cell and to the cell environment. In addition, it must be flexible and resistant to cold flow under pressure of the seal, and it must maintain these characteristics so as to insure a proper seal during long periods of storage. Materials such as nylon, polypropylene, ethylene-tetrafluoroethylene copolymer and high density polyethylene have been found to be suitable as gasket materials for most applications. Conventionally, the gasket is molded as a single piece having no opening which extends fully through the thickness of the gasket. Upon assembly of the gasket with the current collector, the current collector (“nail”) is forced through the gasket material, puncturing the gasket and forming a through hole in the gasket. While this construction generally produces a relatively tight seal, the act of puncturing the gasket may cause particles to break free from the gasket around the puncture opening, causing the grip of the gasket on the current collector to loosen. This may occur during manufacture of the electrochemical cell resulting in a yield loss. One attempt to address this problem may be found in U.S. Pat. No. 5,672,443, the disclosure of which is incorporated herein by reference. The act of puncturing is also believed to leave cracks in the material of the gasket. Over time, the cracks formed in the gasket tend to propagate to form breaches in the gasket through which electrolyte may pass. Thus, the shelf life of the cell can be somewhat compromised.

The affinity of the alkaline electrolyte for wetting the metal current collector, which is exacerbated by the flow of current in the current collector, can render even a tight seal between the gasket and the current collector incapable of completely preventing the escape of electrolyte past the gasket. Surface features of the metal current collector (e.g., scratches) can provide a path for the electrolyte to move past the seal. To combat this, a synthetic rubber sealant is typically applied to the current collector prior to assembly with the gasket. The sealant fills in the scratches (or other surface features) and blocks the electrolyte so that electrolyte will not circumvent the gasket seal. However, the sealant tends to act as a lubricant between the current collector and the gasket. Under the compressive forces applied by the gasket to the current collector after assembly, the current collector may at least partially back out of the gasket. The movement of the current collector away from a position of being fully inserted into the gasket is unacceptable from a manufacturing standpoint. Current collector subassemblies (including the current collector and gasket) in which the current collector has partially backed out of the gasket must be taken off line and reworked or discarded.

Accordingly, there is presently a need for a gasket and an electrochemical cell including such a gasket which provides good, long-lasting sealing and which resists dislocation of the current collector from a fully inserted position in the gasket.

### SUMMARY

In one aspect of the present invention, an electrochemical cell generally comprises a cathode, an anode and a container made of electrically conductive material in which the cathode and the anode are disposed. The container has an end wall and a side wall extending outwardly from the end wall. The side wall has an inner surface. A separator permeable to ions is disposed in the container generally between the cathode and the anode for separating the cathode and the anode. A negative current collector is disposed in the container and in contact with the anode. A gasket for sealing the container at an end generally opposite the end wall of the container comprises a rim, a generally central hub and a web extending between and interconnecting the rim and the hub. The hub is generally tubular in shape and has a passage formed prior to assembly with the current collector to extend completely through an opening at both ends of the hub. The negative current collector extends through the preformed hub passage.

In another aspect of the present invention, a current collector subassembly for an electrochemical cell generally comprises an elongate negative current collector adapted for placement in the electrochemical cell in electrical contact with an anode of the electrochemical cell. A gasket for sealing a container of the electrochemical cell at an end generally opposite an end wall of the container comprises a rim, a generally central hub and a web extending between and interconnecting the rim and the hub. The hub is generally tubular in shape and has a passage formed prior to assembly with the current collector to extend completely through an opening at both ends of the hub. The negative current collector extends completely through the preformed hub passage.

In yet another aspect of the present invention, a method of assembling a negative current collector subassembly for use in an electrochemical cell generally includes the step of aligning an elongate negative current collector with a passage in a hub of a gasket. Relative movement is obtained between the current collector and the gasket so that the current collector enters the hub passage and passes completely through the gasket in the hub passage without penetrating the material of the gasket.

### BRIEF DESCRIPTION OF THE DRAWINGS

FIG. 1 illustrates a cross section of an electrochemical cell including a gasket and a current collector;

FIG. 2 illustrates an enlarged, fragmentary cross section of a current collector subassembly including the gasket and current collector;

FIG. 3 illustrates a perspective of the gasket showing an interior side thereof;

FIG. 4 illustrates a perspective of the gasket showing an exterior side thereof;

FIG. 5 illustrates a cross section of the gasket;

FIG. 6 depicts a cross section of the gasket illustrating insertion of the current collector prior to engagement with a gripping member of the gasket;

FIG. 7 depicts a cross section of the gasket illustrating insertion of the current collector through the gripping member of the gasket;

FIG. 8 illustrates a cross sectional perspective of the assembled gasket and current collector; and

FIG. 9 depicts an enlarged detail of FIG. 2 illustrating how the gripping member wipes sealant from the current collector.

Corresponding reference characters indicate corresponding parts throughout the several views of the drawings.

### DESCRIPTION

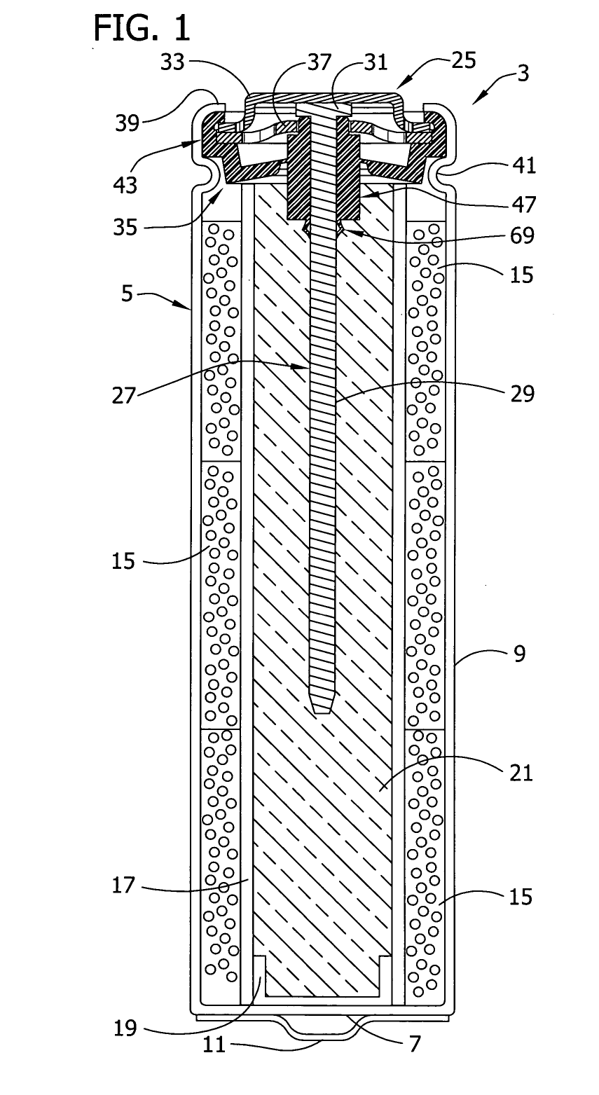

Referring now to the drawings, an alkaline manganese dioxide electrochemical cell (illustrated in FIG. 1 in the form of a AA battery generally indicated at 3) is shown to comprise a container generally indicated at 5 made of an electrically conductive material that forms a positive current collector of the battery. In the illustrated embodiment, the container 5 is drawn steel having a closed bottom formed by an end wall 7 and a cylindrical side wall 9 formed as one piece with the end wall. A positive terminal plate 11 is attached as by welding to the end wall 7 of the metal container 5. The top of the metal container is open. As used herein the singular “side wall” refers not only to a wall like the cylindrical wall 9 illustrated that has a single, continuous curve, but also to side walls (not shown) having other shapes including those formed from multiple flat wall sections. Although illustrated as a AA battery 3, it will be understood that the present invention has application to batteries of all standard sizes (e.g., A, AA, AAA, C and D), as well as to electrochemical cells generally.

Three cathode rings 15 formed of a suitable cathode material, such as manganese dioxide (MnO₂) and appropriate additives (e.g., a binder and electrolyte), are located in the metal container 5 so that they define an open center along the longitudinal axis of the metal container. Any number of cathode rings may be used, including a single piece, tubular cathode (not shown). A tubular separator 17 is located on the internal diameters of the cathode rings 15 by a cup-shaped locator 19 attached to the end wall 7 of the metal container 5. The separator 17 is made of a suitable material permeable to ions, such as a paper material. An anode 21 is located within the separator so that the separator 17 physically separates the anode from the cathode rings 15. The anode 21 can be formed in any suitable manner, and conventionally may be a mixture including an anode metal (e.g., zinc) provided as a powder, an aqueous alkaline electrolyte and a gelling agent. Some suitable anode formulations are discussed in co-assigned U.S. Pat. No. 6,040,088, the disclosure of which is incorporated herein by reference. Additional electrolyte (not shown) may be added to the metal container 5. Suitable electrolytes include potassium hydroxide and sodium hydroxide in an alkaline battery, but other compositions can be used without departing from the scope of the present invention.

A current collector subassembly of the battery 3, generally indicated at 25, includes a negative current collector (indicated generally at 27) or nail that is partially received in the anode 21. The negative current collector 27 is made of a suitable metal such as brass, zinc, zinc alloys or tin plated steel. The current collector 27 has a shank 29 and a head 31 at the upper end (as the battery 3 is oriented in FIG. 1) of the shank that is attached as by welding to a negative terminal plate 33 (broadly, “an outer plate”). The current collector 27 extends through a gasket (generally indicated at 35) that closes the open top of the metal container 5. A washer 37 located between the negative terminal plate 33 and the gasket 35 helps the gasket maintain contact and seal with the interior surface of the metal container 5. The washer 37 is made of an electrically conductive material such as galvanized carbon steel. The metal container 5 has a crimp 39 extending inward at its top end and a groove 41 just below the top end. These deformations 39, 41 of the metal container 5 capture inner and outer sides of the gasket 35 between them and locate the current collector subassembly 25 relative to the metal container. The crimp 39 at the top end also bends over an outer edge portion of a rim 43 of the gasket 35. The description of the battery 3 to this point is substantially conventional, and is one example of an electrochemical cell. Accordingly, only a brief description has been given. Those of ordinary skill in the art will appreciate that changes may be made in this general construction without departing from the scope of the present invention.

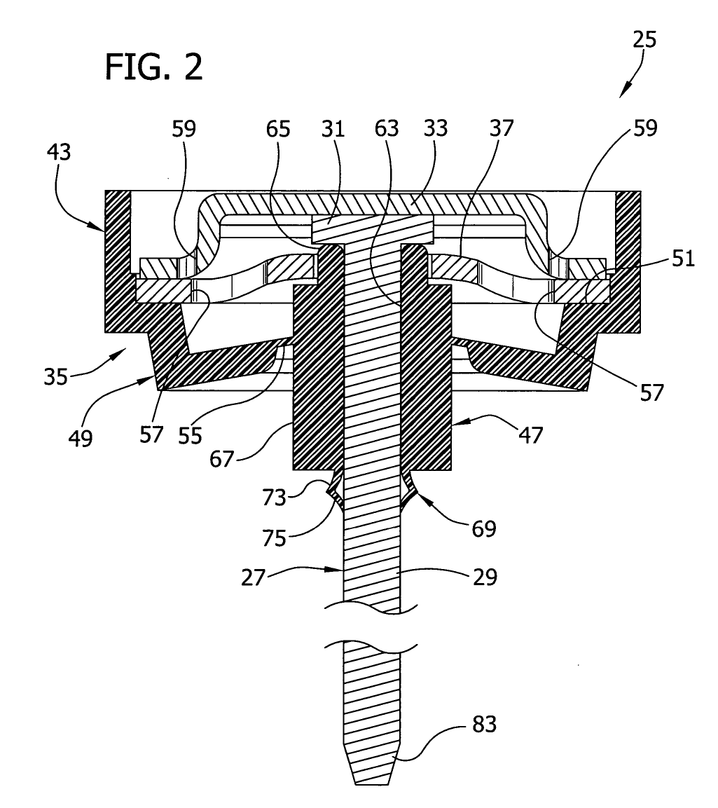

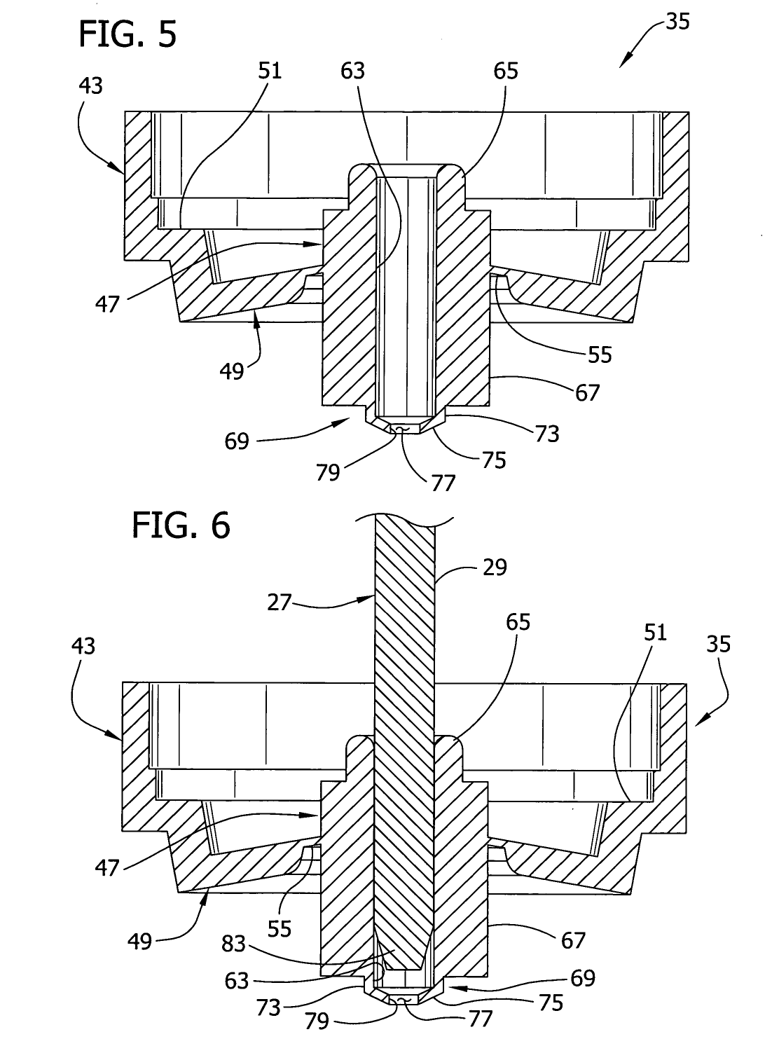

Referring now also to FIGS. 2-5, it may be seen that the gasket 35 has a roughly bowl shape and comprises the outer, annular rim 43, a central hub 47 and an annular web 49 extending between and interconnecting the rim and the hub (all reference numbers designating their subjects generally). As illustrated, the gasket 35 is molded as a single piece of nylon 6,6, although other, multi-piece constructions and materials may be used. Nylon 6,6 has been found to be inert to the electrolyte (e.g., potassium hydroxide) contained in the metal container 5 of alkaline batteries, and yet also sufficiently elastic to deform and function as a seal. Other suitable materials for the gasket include polypropylene, ethylene-tetrafluoroethylene copolymer and high density polypropylene. The rim 43 is generally L-shaped in cross section with a vertical leg of the “L” sealingly engaging the interior of the side wall 9 when assembled in the metal container 5 of the battery 3. The horizontal leg of the “L” forms an annular shoulder 51 on which washer 37 and negative terminal plate 33 are supported. The web 49 extends radially inwardly from the shoulder 51 of the rim 43 to the central hub 47. The rim 43, web 49 and hub 47 (with the current collector 27 received therethrough) seal the interior of the metal container 5.

It is possible for the chemical reactions taking place in the container 5 of the battery 3 to produce a gas as a product of the reactions. Gas production can cause an increase in pressure within the metal container 5 to the point where the crimp 39 may open up and the gasket 35 may spontaneously disassembly from the container. To avoid this undesirable result, web 49 includes an annular vent panel 55 at the location where the web contacts the central hub 47. The vent panel 55 is a region of thinner gasket material. Should pressure rise within the container 5, the web 49 of the gasket 35 is forced upward, and if the pressure gets sufficiently high the vent panel 55 will break allowing the gas to escape past the gasket. Holes 57 are formed in the washer 37 and holes 59 are formed in the negative terminal plate 33 to allow passage of the gas out of the metal container 5. Other venting arrangements well known to those of ordinary skill in the art may be used within the scope of the present invention.

The central hub 47 is generally tubular in shape, having a longitudinal passage 63 that extends completely through the gasket 35. The longitudinal passage 63 is formed in this way during molding of the gasket 35 so that no tearing or puncturing of the gasket is necessary to open the longitudinal passage at both ends so that the current collector 27 can extend through the gasket. An outer end of the hub 47 is formed with a reduced external diameter and defines a collar 65 that receives an internal margin of the washer 37 thereon for locating the washer and gasket 35 radially and axially with respect to each other (see FIG. 2). The diameter of the longitudinal passage 63 extending through the collar 65 is the same as the diameter of the passage extending through a middle region 67 of the hub 47. However, the outer end of the passage 63 in the collar 65 flares outward slightly to facilitate insertion of the current collector 27. The middle region 67 makes up the majority of the length of the hub 47.

A gripping member indicated generally at 69 and having a markedly smaller wall thickness is formed on a second end of the hub 47 opposite the end including the collar 65. The diameter of the longitudinal passage 63 extending through the gripping member 69 is the same as the remainder of the longitudinal passage except at the outer end where the diameter is constricted for reasons described more fully hereinafter. The diameter of the parts of the longitudinal passage 63 having a uniform diameter is in the illustrated embodiment (for a AA battery) about 1.375 mm, which is smaller than the diameter (approximately 1.45 mm) of shank 29 of current collector 27. Therefore, when the current collector 27 is received in the hub 47, there is an interference fit along the uniform diameter portion of the longitudinal passage 63. As another example for a AAA battery (not shown), the diameter of the current collector shank is about 1.15 mm and the longitudinal passage has a diameter of about 1.10 mm in its uniform diameter portion. It will be understood that the dimensions are exemplary only, and the exact dimensions can be other than given herein without departing from the scope of the present invention.

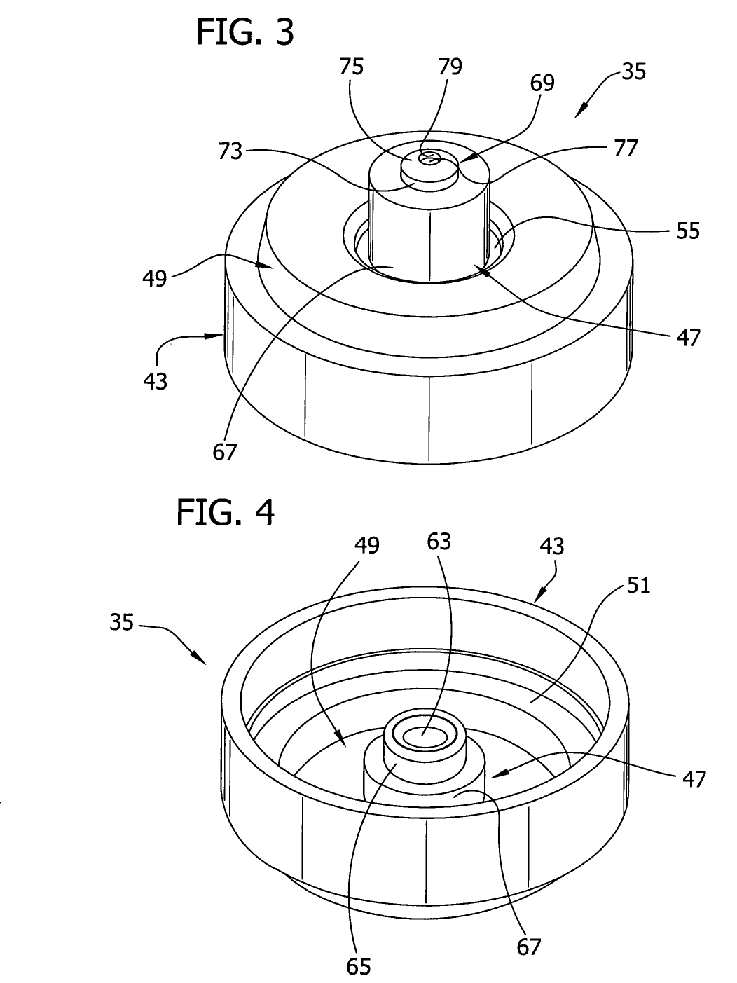

The gripping member 69 includes a cylindrical portion 73 (see FIG. 9) projecting axially outward from the middle region 67 of the central hub 47, and a lip 75. The short cylindrical portion 73 has an internal diameter equal in dimension to the uniform diameter portion of the longitudinal passage 63. The lip 75 projects radially inwardly and axially outwardly at a skew angle to the axis of the longitudinal passage 63. The lip 75 defines at the free end of the gripping member 69 an exit opening 77 (FIG. 3), which has a relaxed diameter of approximately 1 mm. As another example for a AAA battery (not shown), the exit opening may have a diameter of about 0.80 mm. In either case, the ratio of the relaxed diameter of the exit opening 77 (broadly, “constricted portion” of passage 63) to the diameter of the current collector shank 29 is preferably about 65% to 75%. More specifically, the exit opening 77 is defined by a thin “knife” edge 79 of the lip 75. The gripping member 69 is resiliently deformable to accommodate insertion of the current collector shank 29 through the gripping member.

Referring now to FIGS. 6, 7 and 8, a sequence showing the insertion of the current collector shank 29 through the longitudinal passage 63 of the central hub 47 of the gasket 35 is illustrated. Initially, the shank 29 of the current collector 27 is aligned with the longitudinal passage 63 of the hub 47. FIG. 6 illustrates the shank 29 shortly after it has entered the longitudinal passage 63 following alignment. The free end 83 of the shank 29 (i.e., opposite head) is tapered, and in cooperation with the slight outward flare of the longitudinal passage 63 at the collar 65, helps to start the current collector shank into the longitudinal passage. It is noted that this step is most commonly carried out by automated machinery in the manufacture of batteries. As noted previously herein, the diameter of the shank 29 (away from the tapered portion) is larger than the diameter of the longitudinal passage 63 in the collar 65 and middle portion 67 of the hub 47. Accordingly, the hub is deformed radially outwardly and bears against the shank 29 of the current collector 27 in the longitudinal passage 63.

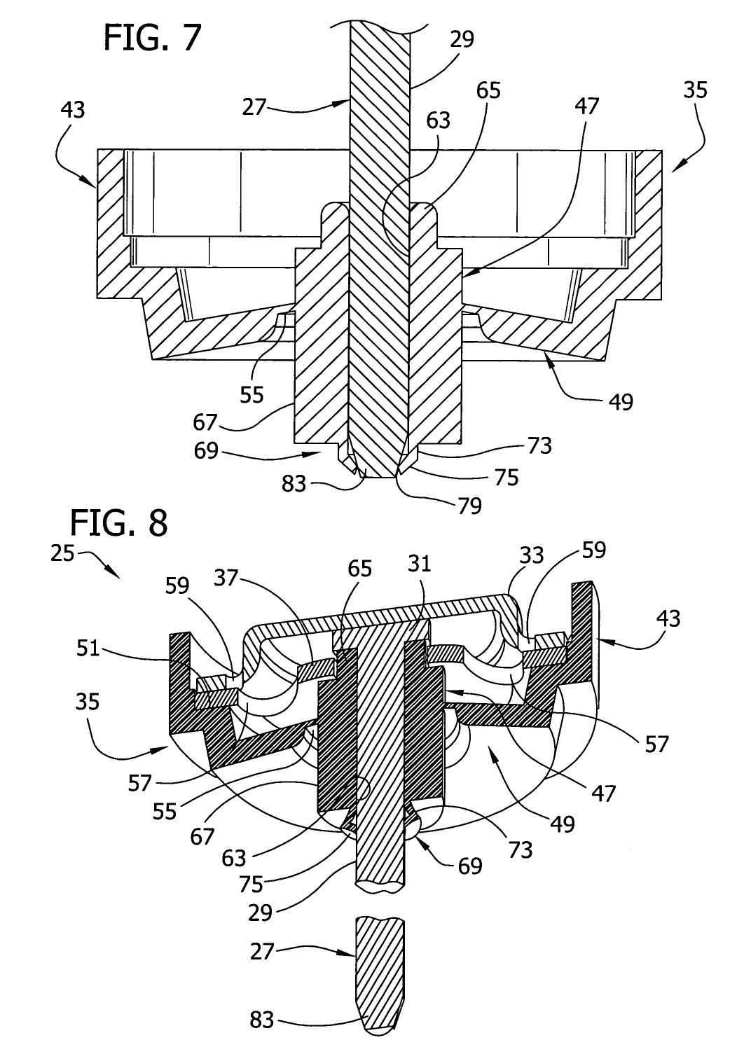

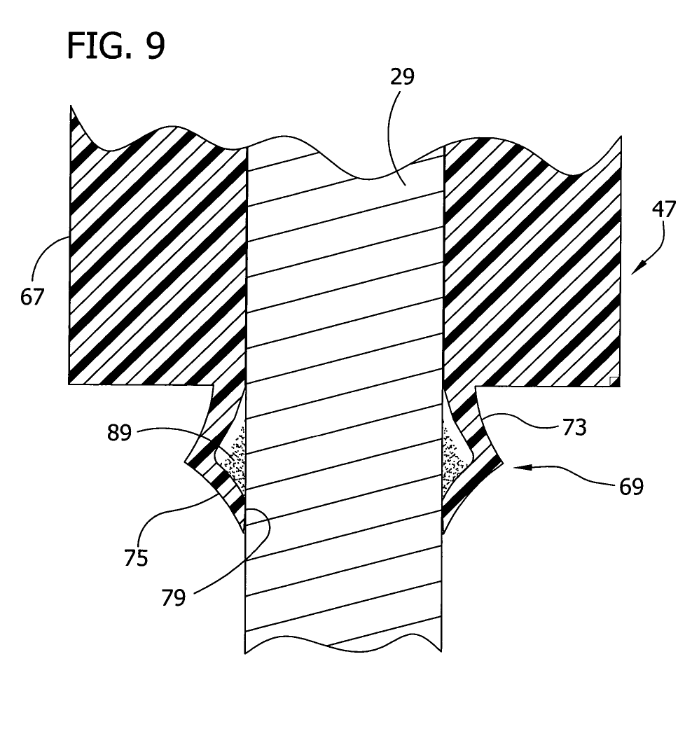

As the tapered free end 83 of the shank 29 reaches the exit opening 77, the leading segment passes through the exit opening, but as illustrated in FIG. 7, the gripping member 69 soon engages the current collector shank free end in the small diameter exit opening. The gripping member 69 has just been engaged by the tapered free end 83 of the shank 29 in FIG. 7, and has not been deformed. As the current collector shank 29 continues to be pushed through the exit opening 77, the shank deforms the gripping member 69 to widen the exit opening and force the cylindrical portion 73 to flex radially outwardly as shown in both FIG. 8 and FIG. 2. The cylindrical portion 73 now assumes a position which is no longer parallel to the axis of the longitudinal passage 63. The material of the gasket 35 permits deformation and flexing but resiliently resists this displacement. Therefore, the knife edge 79 of the gripping member lip 75 bears with substantial pressure against the shank 29 at the exit opening 77.

A synthetic rubber sealant 89 (“flowable sealant”) that is applied to the current collector shank 29 prior to assembly with the gasket 35 is wiped off of the shank as it passes through the exit opening 77 by the knife edge 79 of the gripping member lip 75. A slight build-up of sealant 89 wiped from the shank 29 is illustrated in FIG. 9. There is very little or no sealant 89 at the interface of the knife edge 79 of the lip 75 and the shank 29. Accordingly, there is a better frictional engagement of the lip 75 with the shank 29 at the exit opening 77 than would be possible if there is a significant amount of sealant between the lip and the shank. The synthetic rubber sealant 89 tends to act as a lubricant between the gasket 35 and shank 29, making it more difficult to prevent axial movement of the current collector 27 relative to the gasket. The lip 75 grips the shank 29 firmly against axial movement of the shank relative to the gasket 35. The current collector 27 will not back out of its fully inserted position because of the compressive force applied to the shank 29 by the gasket 35. As a result, manufacturing yield is improved because the current collector subassembly 25 does not come apart after it is put together.

Moreover, the insertion of the current collector shank 29 through the exit opening 77 does not puncture or gouge the material of the gasket 35. The exit opening 77 is able to enlarge because the gasket material is sufficiently elastic, but the structure of the gasket 35 around the opening is substantially undamaged. Thus, there are few if any cracks formed in the gasket material upon insertion of the current collector 27. The absence of cracks or other defects in the gasket 35 around the opening allows the gasket to remain intact around the shank/lip interface for long periods of time. Therefore, the seal achieved by the gasket 35 with the shank 29 at this location is maintained for long periods of time, keeping electrolyte within the metal container 5 and avoiding both reduction in operability of the battery 3 and unsightly corrosion.

The current collector subassembly 25 may also include the negative terminal plate 33 welded to the current collector head 31 and the washer 37. The subassembly 25 can be placed into the metal container 5 already holding the cathode rings 15, anode 21 and separator 17. The groove 41 can be made in the container 5 prior to insertion of the subassembly 25 and locates the subassembly in the container. The end of the shank 29 below the gasket 35 penetrates the gel material of the anode 21 when the current collector subassembly is put into the container 5. The metal container can be crimped (at 39) as described previously to complete the assembly of the battery 3. The crimping of the top end of the metal container 5 produces a corresponding roll over of the rim 43, as may be seen by comparing FIGS. 1 and 2, and secures the current collector subassembly 25 in the container.

In view of the above, it will be seen that the several objects of the invention are achieved and other advantageous results obtained.

When introducing elements of the present invention or the various versions, embodiment(s) or aspects thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above without departing from the scope of the invention, it is intended that all matter contained in the above description and shown in the accompanying drawings shall be interpreted as illustrative and not in a limiting sense.

What is claimed is:

1. An electrochemical cell comprising:
a cathode;
an anode;
a container having an end wall and a side wall extending outwardly from the end wall, the side wall having an inner surface, the cathode and the anode being disposed in the container;
a separator disposed in the container generally between the cathode and the anode;
a negative current collector disposed in the container and in contact with the anode; and
a gasket for sealing the container at an end generally opposite the end wall of the container, the gasket comprising a rim, a generally central hub and a web extending between and interconnecting the rim and the hub, the hub being generally tubular in shape and having a passage formed prior to assembly with the current collector to extend completely through an opening at both ends of the hub;
whereby the negative current collector extends through the preformed hub passage.

2. The electrochemical cell as set forth in claim 1 wherein the gasket is substantially free of any puncture opening formed by the negative current collector.

3. The electrochemical cell as set forth in claim 1 wherein the gasket is formed for gripping the negative current collector to resist withdrawal of the negative current collector from the gasket.

4. The electrochemical cell as set forth in claim 3 wherein the tubular hub includes a resilient gripping member defining a part of the hub passage, the gripping member being resiliently deformed by the negative current collector so that the gripping member bears against and holds the negative current collector in position relative to the gasket.

5. The electrochemical cell as set forth in claim 4 wherein the gripping member defines a constricted portion of the hub passage, the constricted portion having a diameter that is smaller than a diameter of the hub passage away from the constricted portion.

6. The electrochemical cell as set forth in claim 5 wherein the ratio of the diameter of the constricted portion to the diameter of the hub passage away from the constricted portion is about 65% to 75%.

7. The electrochemical cell as set forth in claim 4 further comprising a sealant applied to the negative current collector, and wherein the gripping member is formed to wipe sealant from the negative current collector when the negative current collector is inserted through the hub passage of the gasket.

8. The electrochemical cell as set forth in claim 7 wherein the gripping member comprises an inwardly projecting annular lip engaged with and bearing against the negative current collector.

9. The electrochemical cell as set forth in claim 8 wherein the lip has a knife edge engaged with the negative current collector.

10. The electrochemical cell as set forth in claim 4 wherein the gripping member is located on an end of the hub closest to the end wall of the container.

11. The electrochemical cell as set forth in claim 10 wherein the gasket is molded as a single piece.

12. The electrochemical cell as set forth in claim 1 wherein the tubular hub includes a resilient gripping member defining a part of the hub passage, the gripping member including a lip that projects inwardly toward the axis of the hub passage, the lip being resiliently deformed by the negative current collector.

13. The electrochemical cell as set forth in claim 12 wherein the lip is skew to the axis of the hub passage.

14. The electrochemical cell as set forth in claim 13 wherein the gripping member further comprises a cylindrical wall extending from one end of the hub, the lip extending from an end of the wall opposite the hub.

15. A current collector subassembly for an electrochemical cell comprising:
an elongate negative current collector adapted for placement in the electrochemical cell in electrical contact with an anode of the electrochemical cell;
a gasket for sealing a container of the electrochemical cell at an end generally opposite an end wall of the container, the gasket comprising a rim, a generally central hub and a web extending between and interconnecting the rim and the hub, the hub being generally tubular in shape and having a passage formed prior to assembly with the current collector to extend completely through an opening at both ends of the hub;
the negative current collector extending completely through the preformed hub passage.

16. The current collector subassembly as set forth in claim 15 wherein the gasket is formed for gripping the negative current collector to resist withdrawal of the negative current collector from the gasket.

17. The current collector subassembly as set forth in claim 16 wherein the tubular hub includes a resilient gripping member defining a part of the hub passage, the gripping member being resiliently deformed by the negative current collector so that the gripping member bears against and holds the negative current collector in position relative to the gasket.

18. The current collector subassembly as set forth in claim 17 wherein the gripping member defines a constricted portion of the hub passage, the constricted portion having a diameter that is smaller than a diameter of the hub passage away from the constricted portion.

19. The current collector subassembly as set forth in claim 18 wherein the ratio of the diameter of the constricted portion to the diameter of the hub passage away from the constricted portion is about 65% to 75%.

20. The current collector subassembly as set forth in claim 17 further comprising a sealant applied to the negative current collector, and wherein the gripping member is formed to wipe sealant from the negative current collector when the negative current collector is inserted through the hub passage of the gasket.

21. The current collector subassembly as set forth in claim 20 wherein the gripping member has an inwardly projecting annular lip engaged with and bearing against the negative current collector.

22. The current collector subassembly as set forth in claim 21 wherein the lip has a knife edge engaged with the negative current collector.

23. The current collector subassembly as set forth in claim 17 wherein the gripping member is located on one end of the hub.

24. The current collector subassembly as set forth in claim 21 wherein the gasket is molded as a single piece.

25. The current collector subassembly as set forth in claim 15 further comprising an outer plate welded to the current collector.

26. The current collector subassembly as set forth in claim 25 further comprising a washer, the current collector extending through the washer, the washer being located generally between the outer plate and the gasket.

27. The current collector subassembly as set forth in claim 15 wherein the tubular hub includes a resilient gripping member defining a part of the hub passage, the gripping member including a lip that projects inwardly toward the axis of the hub passage, the lip being resiliently deformed by the negative current collector.

28. The current collector subassembly as set forth in claim 27 wherein the lip is skew to the axis of the hub passage.

29. The current collector subassembly as set forth in claim 28 wherein the gripping member further comprises a cylindrical wall extending from one end of the hub, the lip extending from an end of the wall opposite the hub.

30. A method of assembling a negative current collector subassembly for use in an electrochemical cell, the method comprising the steps of:
aligning an elongate negative current collector with a passage in a hub of a gasket;
obtaining relative movement between the current collector and the gasket so that the current collector enters the hub passage and passes completely through the gasket in the hub passage without penetrating the material of the gasket.

31. The method as set forth in claim 30 wherein said step of obtaining relative movement comprises resiliently deforming the gasket as the current collector passes through the gasket in the hub passage whereby the gasket bears against the current collector.

32. The method as set forth in claim 30 further comprising applying a flowable sealant to the current collector, and wherein said step of obtaining relative movement comprises wiping sealant from the current collector with a wiper formed with the gasket as the current collector passes out of the hub passage.

33. The method of assembling an electrochemical cell comprising assembling the negative current collector subassembly according to claim 30, the method further comprising the steps of:
placing a cathode into a container through an open end of the container;
placing an anode in the container through the open end of the container;
inserting the current collector subassembly into the container through the open end of the container so that the current collector contacts the anode;
sealing the container to the gasket of the current collector subassembly thereby to substantially close the open end of the container.
